(19) United States
(12) Patent Application Publication
(10) Pub. No.: US 2026/0357721 A1
(43) Pub. Date: Nov. 12, 2026

(54) TURBINE EXHAUST DUCT WITH SHIELDING PLATES

(71) Applicant: PRATT & WHITNEY CANADA CORP., Longueuil (CA)

(72) Inventors: Guy LEFEBVRE, St-Bruno-de-Montarville (CA); François DOYON, Ste-Julie (CA)

(21) Appl. No.: 19/201,276

(22) Filed: May 7, 2025

(51) Int. Cl. F01D 25/30; F01D 25/14

(52) U.S. Cl. CPC F01D 25/30; F01D 25/145; F05D 2220/323

(57) ABSTRACT

A turbine exhaust duct (TED) for an aircraft engine, has: an annular inlet conduit extending around a central axis for directing combustion gases generally in an axial direction; outlet conduits communicating with the inlet conduit and extending generally radially outward relative to the inlet conduit, the outlet conduits extending from inlet ends at intersections with the inlet conduit to outlet ends, an outlet conduit of the outlet conduits having: a transition area transitioning from a mainly axial direction to a mainly radial direction; and a shielding plate secured to the outlet conduit and overlapping the transition, the shielding plate including a material having a melting point higher than that of the outlet conduits.

### TECHNICAL FIELD

The application relates generally to aircraft engines and, more particularly, to exhaust cases of such engines.

### BACKGROUND

Exhaust ducts are disposed downstream of turbine sections and are configured for evacuating combustion gases that have been used to power the turbine sections. These combustion gases are hot and care should be taken to ensure that the exhaust ducts sustain these harsh conditions. Existing exhaust ducts are satisfactory to some extend, but improvements are always sought.

### SUMMARY

In one aspect, there is provided a turbine exhaust duct (TED) for an aircraft engine, comprising: an annular inlet conduit extending around a central axis for directing combustion gases generally in an axial direction; outlet conduits communicating with the inlet conduit and extending generally radially outward relative to the inlet conduit, the outlet conduits extending from inlet ends at intersections with the inlet conduit to outlet ends, an outlet conduit of the outlet conduits having: a transition area transitioning from a mainly axial direction to a mainly radial direction; and a shielding plate secured to the outlet conduit and overlapping the transition, the shielding plate including a material having a melting point higher than that of the outlet conduits.

The TED described above may include any of the following features, in any combinations.

In some embodiments, the material is a thermal barrier coating.

In some embodiments, the shielding plate includes a substrate coated with the material.

In some embodiments, the shielding plate has a gaspath side exposed to combustion gases and a rear side opposite the gaspath side and facing the transition area of the outlet conduit, the shielding plate having threaded shanks protruding from the rear side and extending through registering apertures defined at the transition area of the outlet conduit, the shielding plate secured to the transition area via the threaded shanks and nuts threaded to the threaded shanks.

In some embodiments, the registering apertures of the transition area are elongated, washers disposed between the nuts and the outlet conduit, the washers being elongated to each overlap an entirety of a respective one of the registering apertures.

In some embodiments, the outlet conduit defines a bore at the transition area, the bore overlapped by the shielding plate.

In some embodiments, a sealing member is disposed between the shielding plate and the transition area of the outlet conduit, the sealing member surrounding the bore.

In some embodiments, the rear side of the shielding plate defines a groove between ribs, the sealing member received within the groove.

In some embodiments, posts are protruding from the shielding plate and abutting the outlet conduit, the posts having a length being less than that of the threaded shanks.

In some embodiments, the outlet conduit defines a flow passage for the combustion gases, the transition area defines a recessed portion recessed outwardly away from the flow passage and sized for accommodating the shielding plate.

In another aspect, there is provided a reverse-flow gas turbine engine, comprising: an outer case assembly extending around a central axis and enclosing a core, the core including a compressor section, a combustor, and a turbine section, the turbine section located forward of the combustor and of the compressor section relative to a direction of travel of the reverse-flow gas turbine engine, the outer case assembly including an exhaust case defining openings; a turbine exhaust duct fluidly communicating with the turbine section for receiving combustion gases, the turbine exhaust duct having: an annular inlet conduit extending around the central axis; and outlet conduits communicating with the annular inlet conduit and extending through the openings of the exhaust case, the outlet conduits extending from inlet ends at intersections with the annular inlet conduit to outlet ends, an outlet conduit of the outlet conduits having: a transition area transitioning from a mainly axial direction to a mainly radial direction; and a shielding plate secured to the transition area, the shielding plate being more resistant to the combustion gases than the outlet conduits.

The reverse-flow gas turbine engine described above may include any of the following features, in any combinations.

In some embodiments, the shielding plate includes a thermal barrier coating on a gaspath side thereof, the gaspath side facing flow passages defined by the outlet conduits.

In some embodiments, the shielding plate includes a substrate coated with the thermal barrier coating.

In some embodiments, the shielding plate has a gaspath side exposed to the combustion gases and a rear side opposite the gaspath side and facing the transition area of the outlet conduit, the shielding plate having threaded shanks protruding from the rear side and extending through registering apertures defined by the transition area of the outlet conduit, the shielding plate secured to the transition area via the threaded shanks and nuts threaded to the threaded shanks.

In some embodiments, the registering apertures of the transition area are elongated, washers disposed between the nuts and the outlet conduit, the washers being elongated to each overlap an entirety of a respective one of the registering apertures.

In some embodiments, the outlet conduit defines a bore being overlapped by the shielding plate.

In some embodiments, a sealing member is disposed between the shielding plate and the transition area of the outlet conduit, the sealing member surrounding the bore.

In some embodiments, the rear side of the shielding plate defines a groove between ribs, the sealing member received within the groove.

In some embodiments, posts are protruding from the shielding plate and abutting the outlet conduit, the posts having a length being less than that of the threaded shanks.

In some embodiments, the outlet conduit defines a flow passage for the combustion gases, the transition area defines a recessed portion recessed outwardly away from the flow passage and sized for accommodating the shielding plate.

### DESCRIPTION OF THE DRAWINGS

Reference is now made to the accompanying figures in which:

FIG. 1 is a schematic cross-sectional view of an aircraft engine depicted as a turboprop gas turbine engine;

FIG. 2 is a three dimensional view of an exhaust system of the aircraft engine of FIG. 1;

FIG. 3 is a cross-sectional view of the exhaust system of FIG. 2;

FIG. 4 is a three dimensional view of a turbine exhaust duct of the exhaust system;

FIG. 5 is another three dimensional view of the turbine exhaust duct of FIG. 4;

FIG. 6 is a three dimensional gaspath side view of a shielding plate to be used with the turbine exhaust duct of FIGS. 4-5;

FIG. 7 is a three dimensional rear side view of the shielding plate;

FIG. 8 is a cutaway view of a portion of the turbine exhaust duct of FIG. 4 illustrating the shielding plate of FIGS. 6-7 secured thereto;

FIG. 9 is a three dimensional gaspath side view of a transition area of the turbine exhaust duct of FIG. 8;

FIG. 10 is a three dimensional rear side view of the transition area of the turbine exhaust duct of FIG. 5; and

FIG. 11 is a three dimensional rear view of the exhaust system of FIG. 2 illustrating fastening member used for securing the shielding plate to the turbine exhaust duct.

### DETAILED DESCRIPTION

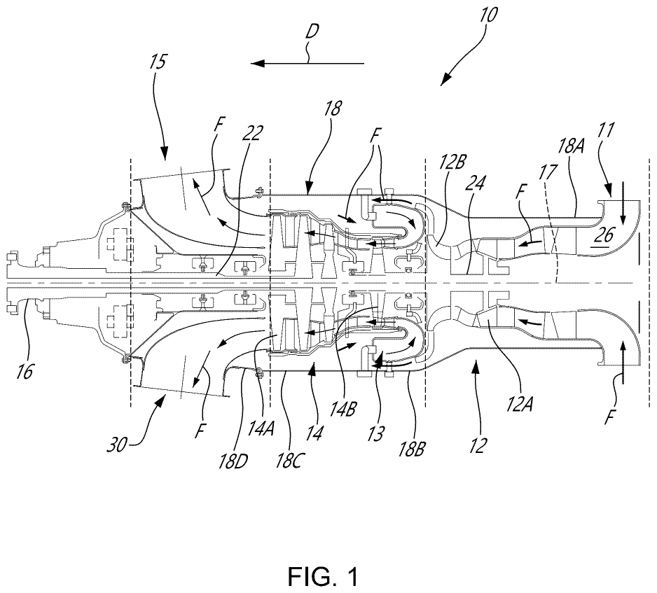

FIG. 1 illustrates an aircraft engine depicted as a gas turbine engine 10 of a type preferably provided for use in subsonic flight, generally comprising in serial flow communication an air inlet 11, a compressor section 12 for pressurizing the air from the air inlet 11, a combustor 13 in which the compressed air is mixed with fuel and ignited for generating an annular stream of hot combustion gases, a turbine section 14 for extracting energy from the combustion gases, an exhaust system 15 through which the combustion gases exit the gas turbine engine 10. The gas turbine engine 10 has a central axis 17. The gas turbine engine 10 in FIG. 1 is a turboprop engine and includes an output shaft 16, which may drive a propulsor, such as a rotor or propeller, for providing thrust for flight and taxiing. It is understood that the gas turbine engine 10 can adopt various other configurations. For instance, the gas turbine engine could be configured as a turboshaft engine having an output shaft connectable to a rotatable load, such as a helicopter rotor or the like.

The gas turbine engine 10 has an outer case assembly 18 housing a core through which gases flow and which includes most of the turbomachinery of the gas turbine engine 10. The illustrated gas turbine engine 10 is a “reverse-flow” engine 10 because gases flow through the core from the air inlet 11 at a rear or aft portion of the gas turbine engine 10, to the exhaust system 15 at a front portion of the gas turbine engine 10. This is in contrast to “through-flow” gas turbine engines in which gases flow through the core of the gas turbine engine from a front portion to a rear portion. The direction of the flow of gases through the gas turbine engine 10 is shown in FIG. 1 with arrows F.

It will thus be appreciated that the expressions “forward” and “aft” used herein may refer to the relative disposition of components of the gas turbine engine 10, in correspondence to the “forward” and “aft” directions of the gas turbine engine 10 and aircraft including the gas turbine engine 10 as defined with respect to the direction of travel D. In the embodiment shown, a component of the gas turbine engine 10 that is “forward” of another component is arranged within the gas turbine engine 10 such that it is located closer to the output shaft 16. Similarly, a component of the gas turbine engine 10 that is “aft” of another component is arranged within the gas turbine engine 10 such that it is further away from the output shaft 16.

Still referring to FIG. 1, the core of the gas turbine engine 10 may include one or more spools. The illustrated embodiment is a two-spool engine including a low pressure (LP) spool and a high pressure (HP) rotatable about the central axis 17 to perform compression to pressurize the air received through the air inlet 11, and to extract energy from the combustion gases before they exit the core via the exhaust system 15 at a forward end of the core. The core may include other components as well, including, but not limited to internal combustion engines (e.g. rotary engines such as Wankel engines for compounding power with a turbine of the turbine section), gearboxes, tower shafts, and bleed air outlets.

Each spool generally includes at least one component to compress the air that is part of the compressor section 12, and at least one component to extract energy from the combustion gases that is part of the turbine section 14. More particularly, according to the illustrated embodiment, the LP spool has an LP turbine 14A which extracts energy from the combustion gases, and an LP compressor 12A for pressurizing the air. The LP turbine 14A and the LP compressor 12A can each include one or more stages of rotors and stators, depending upon the desired engine thermodynamic cycle, for example. The LP spool further comprises an LP shaft 22 drivingly connecting the LP turbine 14A to the LP compressor 12A. Gears (not shown) can be provided to allow the LP compressor 12A to rotate at a different speed than the LP turbine 14A. The LP turbine 14A may also drivingly connected to the output shaft 16 via a RGB.

Still referring to FIG. 1, the HP spool comprises an HP turbine 14B drivingly engaged (e.g., directly connected) to a HP compressor 12B by a high pressure shaft 24. Similarly to the LP turbine 14A and the LP compressor 12A, the HP turbine 14B and the HP compressor 12B can each include one or more stages of rotors and stators. The LP compressor 12A, the HP compressor 12B, the combustor 13, the HP turbine 14B and the LP turbine 14A are in serial flow communication via a gas path 26 being annular and extending through the core about the central axis 17. The gas path 26 leads to the exhaust system 15 downstream of the turbine section 14.

The outer case assembly 18 includes a plurality of cases disposed along the central axis 17 of the gas turbine engine 10. These cases are secured to one another at mating flanges using suitable fastening means, such as nuts and bolts. Any fastening means are contemplated. The outer case assembly 18 includes a compressor case 18A enclosing the compressor section 12, a combustor case 18B enclosing the combustor 13, a turbine case 18C enclosing the turbine section 14, and an exhaust case 18D being part of the exhaust system 15.

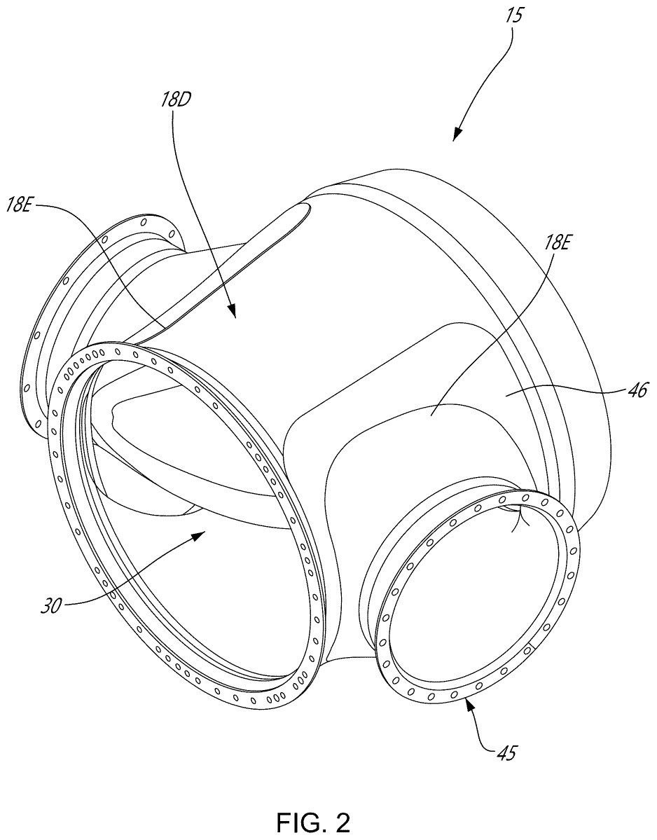

Referring to FIGS. 1-3, the exhaust system 15 of the gas turbine engine 10 comprises a turbine exhaust duct (TED) 30 secured to the exhaust case 18D. The exhaust case 18D extends circumferentially around the central axis 17 and defines openings 18E, two openings in this embodiment, sized for receiving portions of the turbine exhaust duct 30 that will be described below. The two openings 18E may be diametrically opposed to one another. More or less than two openings may be used in some embodiments.

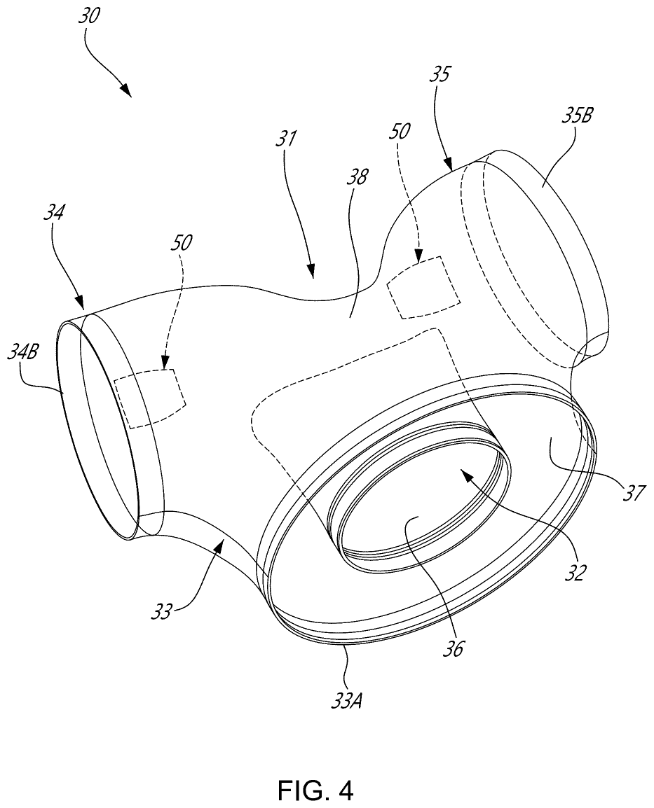

Referring now to FIG. 4, the turbine exhaust duct 30 is described in more detail. The turbine exhaust duct 30 is used for exhausting combustion gases received from the last stage of the LP turbine 14A. According to the illustrated embodiment, the turbine exhaust duct 30 is a non-axisymmetric dual port exhaust duct configured for directing combustion gases laterally on opposed sides of the outer case assembly 18 of the gas turbine engine 10. The turbine exhaust duct 30 is qualified as “non-axisymmetric” because the two exhaust ports thereof are not coaxial to the central axis 17 of the gas turbine engine (i.e. the exhaust flow discharged from the exhaust duct is not axial, it is rather directed in a direction that diverges from the central axis 17). According to at least some embodiments, the TED 30 has a generally “Y-shaped” body 31 including an inlet conduit 33 extending axially around the central axis 17 for receiving the annular flow of combustions gases discharged from the last stage of LP turbine 14A, and first and second outlet conduits 34, 35 branching off laterally from the inlet conduit 33. According to some embodiments, the first and second outlet conduits 34, 35 are identical.

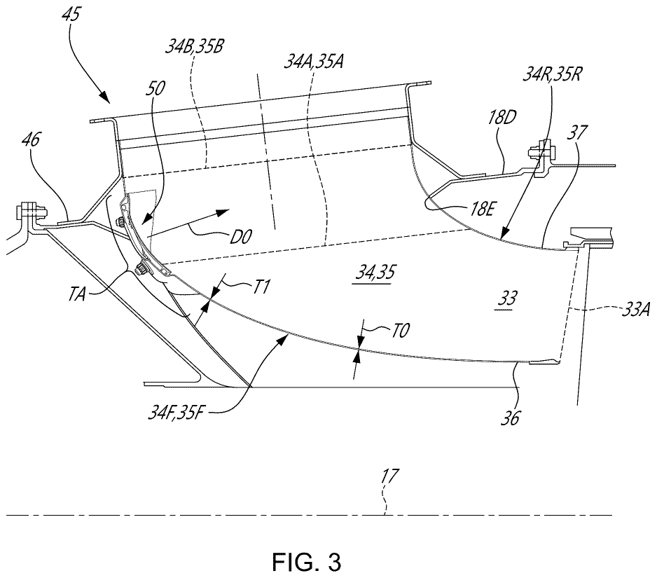

As can be appreciated from FIG. 1, the downstream end of each outlet conduit 34, 35 projects outwardly of the exhaust case 18D. As best shown in FIG. 3, each outlet conduit 34, 35 terminates into an exhaust port. The outlet conduits extend along respective axes that intersect the central axis 17. According to the illustrated embodiment, these axes has a main radial component and a secondary (i.e. smaller) axial component relative to the central axis 17. Stated differently, the exhaust ports of the outlet conduits 34, 35 are oriented to direct the combustion gases mainly in a radially outward direction. According to some embodiments, the exhaust port opening of the outlet conduits 34, 35 are circular. However, it is understood that other geometries are contemplated as well (e.g. oval).

Referring to FIGS. 3-5, the turbine exhaust duct 30, in this embodiment is a dual ports exhaust duct, and is formed by a generally Y-shaped body 31. The body 31 of the turbine exhaust case 30 defines a fluid flow passage(s) about a central bore 32 for accommodating a shaft engine. The fluid flow passage of the annular body 31 generally includes the inlet conduit 33 through which the bore 32 extends, and in this example the two outlet conduits 34, 35 branching off from the inlet conduit 33 and extending radially away therefrom relative to the central axis 17. It is understood that the inlet and outlet conduits 33, 34, 35 may adopt various configurations. For instance, they can take the form of cylindrically straight or curved conduits. If desired the body 31 may include more than two outlet conduits. The inlet conduit 33 may be provided in the form of an annular inlet conduit 33 wherein the inlet conduit 33 is connected to and communicates with the outlet conduits 34, 35. The outlet conduits 34, 35 may not be perpendicularly positioned relative to the inlet conduit 33 (i.e. be purely radially oriented with respect thereto), but rather may extend both radially and axially with respect thereto. Therefore, the body 31 could adopt various configurations including T-shaped and Y-shaped configurations. It is understood that any suitable configurations for the inlet and exhaust conduits may be used.

The inlet conduit 33 includes an inlet end 33A located adjacent the turbine section 14 for receiving combustion gases therefrom. The outlet conduits 34, 35 are generally cylindrical in shape in this example (though any suitable shape may be employed) and have respective outlet centerlines which extend at an angle relative to each other. As shown in FIGS. 3 and 4, the outlet conduits 34, 35 have corresponding inlet ends 34A, 35A (FIG. 3) and outlet ends 34B, 35B. The inlet ends 34A, 35A are defined at the intersection between the inlet conduit 33 and the outlet conduits 34, 35, as shown schematically by the dotted lines in FIG. 3.

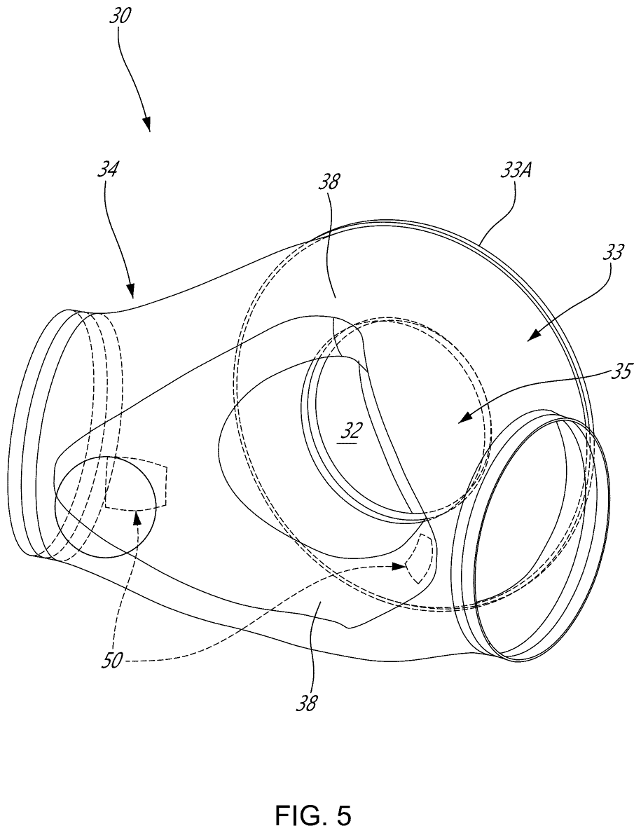

Referring to FIGS. 4-5, the inlet conduit 33 is annular about the central axis 17, which also defines the central axis of the inlet conduit 33. The inlet conduit 33 is defined by an inner peripheral wall 36 and an outer peripheral wall 37. The outer peripheral wall 37 is a circumscribing wall of the inlet conduit 33, and constitutes a periphery of the inlet conduit 33. The inlet conduit 33 may include two circumferentially spaced-apart splitters 38. The splitters 38 may take the form of raises or bumps formed inside the body 31 at a bottom of the inlet conduit 33 and project in a direction toward the central axis 17. The splitters 38 are configured to split the inlet flow in two to direct the two flows towards the outlet conduits 34, 35. The splitters 38 may be omitted in some configurations.

Still referring to FIGS. 4-5, the outer peripheral wall 37 and the inner peripheral wall 36 are connected to one another at the outlet ends 34B, 35B of the outlet conduits 34, 35. It may therefore be said that the outlet conduits 34, 35 are defined conjointly by the inner peripheral wall 36 and the outer peripheral wall 37. In other words, the inner peripheral wall 36 and the outer peripheral wall 37 are cylindrically shaped at the inlet end 33A of the inlet conduit 33 and their shape diverge from the central axis 17 and merge together to conjointly define the outlet ends 34B, 35B of the outlet conduits 34, 35.

Referring more particularly to FIG. 3, the outlet conduits 34, 35, only one shown here for clarity, has a forward section 34F, 35F and a rearward section 34R, 35R. These sections conjointly define the outlet ends 34B, 35B of the outlet conduits 34, 35. The forward section 34F, 35F has a transition area TA where the orientation shifts from mainly axial to mainly radial relative to the central axis 17. As shown in FIG. 3, the forward section 34F, 35F is located axially further away from the turbine section and at least partially faces the inlet end 33A of the inlet conduit 33. This section is mostly responsible for deviating the flow of combustion gases from a substantially axial orientation to a substantially radial orientation. In the context of the present disclosure, the expression “mainly” in “mainly axial” implies 50% or more. Thus, as illustrated in FIG. 3, the forward section 34F, 35F is oriented mainly axially upstream of the transition area and is oriented mainly radially downstream of the transition area relative to a flow of the combustion gases in the turbine exhaust duct 30. Put differently, the transition area corresponds to a portion of the forward section 34F, 35F facing a direction D0 being mainly axial relative to the central axis 17.

It has been observed by inventors of the present disclosure that, at engine start up, the flow of hot combustion gases through the turbine exhaust duct 30 may generate thermal-induced displacement at locations where the turbine exhaust duct 30 is secured to surrounding structure. These thermal displacement may impair performance of the turbine exhaust duct 30. There is thus a desire to mitigate thermal fight and allow thermal growth of the turbine exhaust duct 30. The thermal fights occur particularly at and/or near the transition area that is the most impinged by those hot combustion gases.

Referring to FIGS. 3 and 6-7, to at least partially alleviate these drawbacks, shielding plates 50 are secured to the forward sections 34F, 35F of the outlet conduits 34, 35, more specifically to the transition areas TA of the outlet conduits 34, 35. The shielding plate 50 may be removable from the turbine exhaust duct 30 to be replaced when required. The shielding plate 50 overlaps the transition area of the forward section 34F, 35F. The shielding plate 50 is constructed from a material having a melting point being higher than that of the outlet conduits 34, 35. For instance, the shielding plate 50 may be made of ceramic or other heat-resistant material such as silicon carbide, titanium nitride, to name a few, or any other suitable material that may also be used for thermal barrier coating.

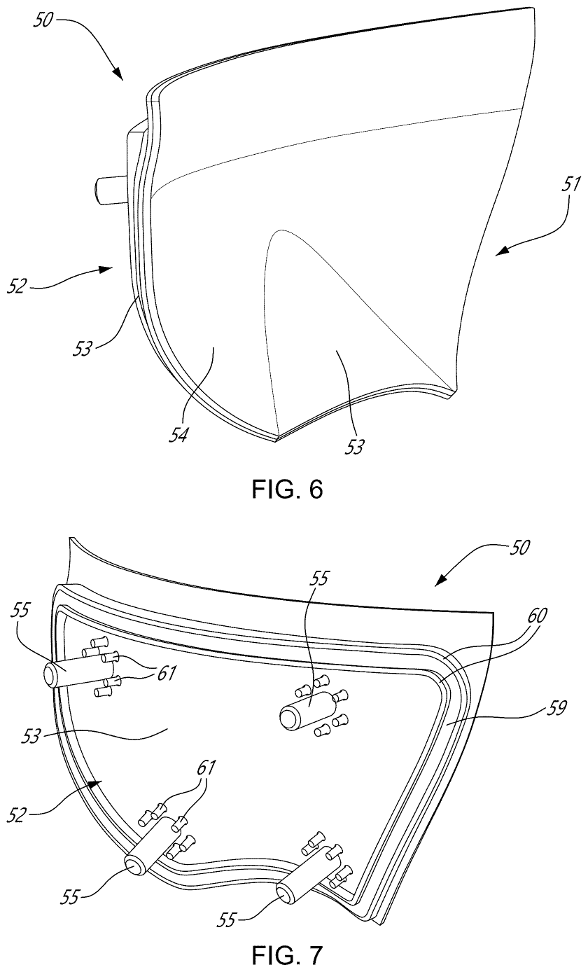

As depicted in FIG. 6, the shielding plate 50 has a gaspath side 51 and a rear side 52 opposite the gaspath side 51. The gaspath side 51 faces a gaspath defined by the turbine exhaust duct 30 and via which the combustion gases flow. The shielding plate 50 may include a substrate 53 onto which is deposited a thermal barrier coating 54. The substrate 53 may be made of Inconel^{TM} 625 or other suitable material. The thermal barrier coating 54 is deposited on a gaspath side 51 of the substrate 53 such that the gaspath side 51 of the shielding plate 50 is defined by the thermal barrier coating 54. As mentioned above, this coating may be made of made of ceramic or other heat-resistant material such as silicon carbide, titanium nitride, to name a few, or any other suitable material that may also be used for thermal barrier coating. In other words, the shielding plate 50 is more resistant to the combustion gases than the outlet conduits 34, 35. The shielding plate may not need a substrate and may be made entirely of ceramic or other suitable heat-resistant material.

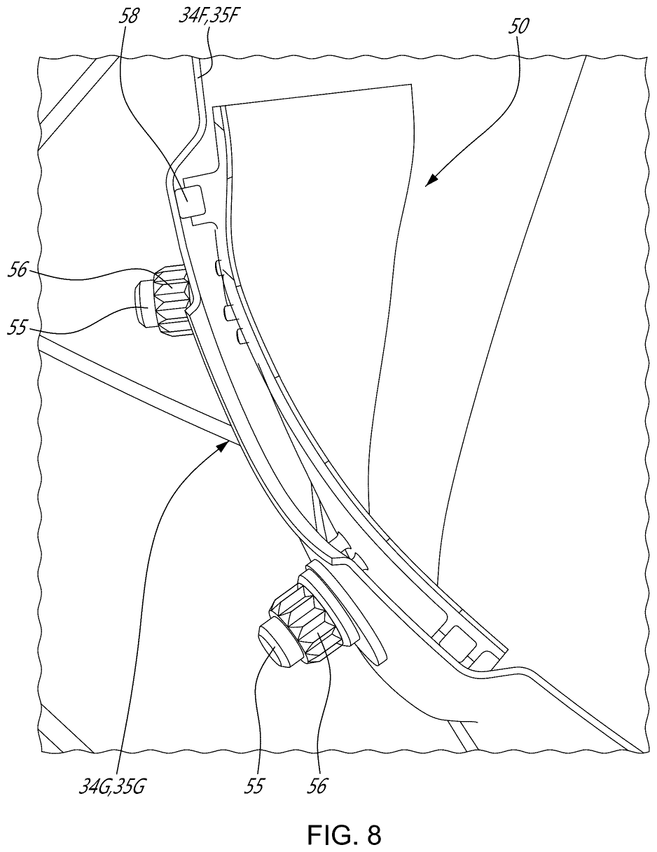

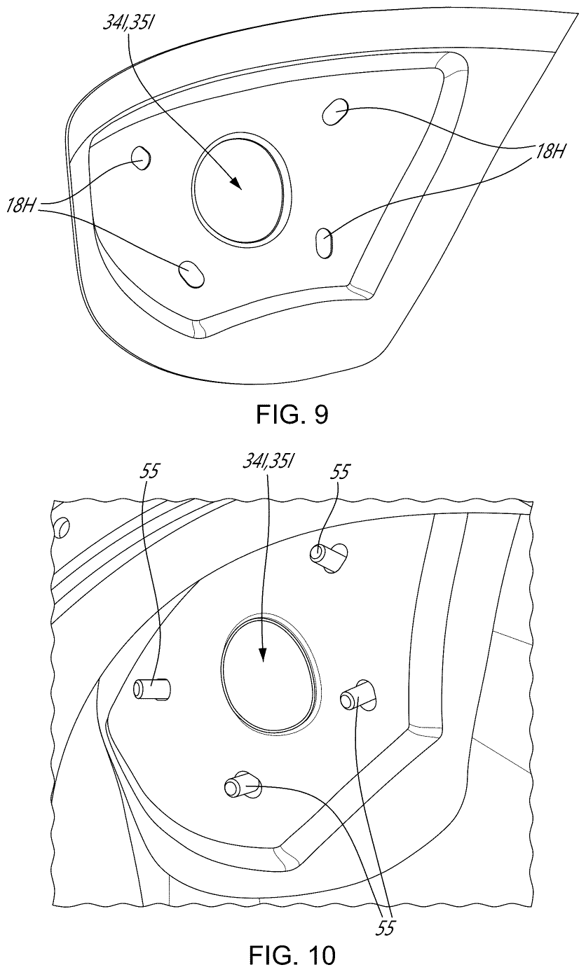

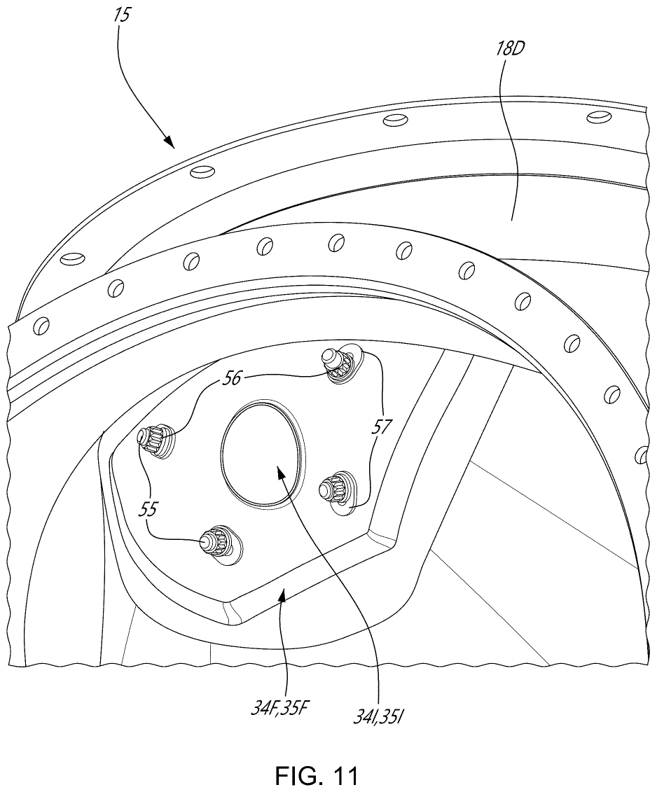

Referring more particularly to FIG. 7, the shielding plate 50 has threaded shanks 55 protruding from the rear side 52 and extending through registering apertures 18H (FIG. 9) defined by the forward section 34F, 35F of the outlet conduit 34, 35. The shielding plate 50 is secured to the forward section 34F, 35F via the threaded shanks 55 and nuts 56 (FIG. 8) threaded to the threaded shanks 55. As illustrated in FIG. 9, the apertures 18H are elongated to provide the necessary clearance to insert the threaded shanks 55 into the apertures 18H. As depicted in FIG. 11, washers 57 are disposed between the outlet conduit 34, 35 and the nuts 56, and the washers are also elongated to overlap an entirety of the apertures 18H to minimize leakage of combustion gases.

Referring more particularly to FIG. 8, in this embodiment, each outlet conduit, 34, 35 defines a recessed portion 34G, 35G at the transition region to accommodate the shielding plate 50. The recessed portion 34G, 35G is recessed outwardly away from a flow passage defined by the turbine exhaust duct 30. A size (e.g., depth, width, height) of this recessed portion 34G, 35G is selected so that the gaspath side 51 of the shielding plate 50 is as flush as possible with a remainder of the outlet conduit 34, 35.

Referring now to FIGS. 7 and 9, to further alleviate thermal stress, a bore 34I, 35I is defined through the outlet conduit 34, 35 at the transition area and is overlapped by the shielding plate 50. This bore 34I, 35I may contribute in distributing the thermal stress. To limit leakage of combustion gases via this bore 34I, 35I, a sealing member 58 (FIG. 8) is disposed between the shielding plate 50 and the forward section 34F, 35F of the outlet conduit 34, 35. The sealing member 58 may be a rope seal or any other suitable seal. The sealing member 58 surrounds the bore 34I, 35I. In some embodiments, the sealing member 58 is received within a groove 59 (FIG. 7) defined by the rear side 52 of the shielding plate 50. The groove 59 may be located between two ribs 60 extending around a periphery of the shielding plate 50 and protruding from the rear side 52.

To avoid deforming the outlet conduit 34, 35 during tightening of the nuts 56, the shielding plate 50 further includes posts 61 protruding from the rear side 52 of the shielding plate 50 and abutting the outlet conduit 34, 35. As depicted, the posts 61 have a length being less than that of the threaded shanks 55. In this embodiment, each of the threaded shanks 55 is surrounded by a plurality of posts 61, six in this embodiment but more or less is used. These posts 61 are configured to abut the outlet conduit 34, 35 once the sealing member 58 has been suitably compressed and to avoid deforming said conduit via over tightening the nuts 56.

The exemplified turbine exhaust duct 30 having the shielding plates 50 may allow the reverse flow exhaust duct to survive in extreme high temperatures. It may increase life of the part while reducing repair costs during engine overhaul.

In the context of the present disclosure, the expressions “substantially” as in “substantially radial” implies that a main component of the direction is radial even if the direction may have one or both of an axial and circumferential component. In other words, by being “substantially radial”, the radial component of the direction is greater than the axial component.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A turbine exhaust duct (TED) for an aircraft engine, comprising:
an annular inlet conduit extending around a central axis for directing combustion gases generally in an axial direction;
outlet conduits communicating with the inlet conduit and extending generally radially outward relative to the inlet conduit, the outlet conduits extending from inlet ends at intersections with the inlet conduit to outlet ends, an outlet conduit of the outlet conduits having:
a transition area transitioning from a mainly axial direction to a mainly radial direction; and
a shielding plate secured to the outlet conduit and overlapping the transition, the shielding plate including a material having a melting point higher than that of the outlet conduits.

2. The TED of claim 1, wherein the material is a thermal barrier coating.

3. The TED of claim 2, wherein the shielding plate includes a substrate coated with the material.

4. The TED of claim 1, wherein the shielding plate has a gaspath side exposed to combustion gases and a rear side opposite the gaspath side and facing the transition area of the outlet conduit, the shielding plate having threaded shanks protruding from the rear side and extending through registering apertures defined at the transition area of the outlet conduit, the shielding plate secured to the transition area via the threaded shanks and nuts threaded to the threaded shanks.

5. The TED of claim 4, wherein the registering apertures of the transition area are elongated, washers disposed between the nuts and the outlet conduit, the washers being elongated to each overlap an entirety of a respective one of the registering apertures.

6. The TED of claim 4, wherein the outlet conduit defines a bore at the transition area, the bore overlapped by the shielding plate.

7. The TED of claim 6, comprising a sealing member disposed between the shielding plate and the transition area of the outlet conduit, the sealing member surrounding the bore.

8. The TED of claim 7, wherein the rear side of the shielding plate defines a groove between ribs, the sealing member received within the groove.

9. The TED of claim 4, comprising posts protruding from the shielding plate and abutting the outlet conduit, the posts having a length being less than that of the threaded shanks.

10. The TED of claim 1, wherein the outlet conduit defines a flow passage for the combustion gases, the transition area defines a recessed portion recessed outwardly away from the flow passage and sized for accommodating the shielding plate.

11. A reverse-flow gas turbine engine, comprising:
an outer case assembly extending around a central axis and enclosing a core, the core including a compressor section, a combustor, and a turbine section, the turbine section located forward of the combustor and of the compressor section relative to a direction of travel of the reverse-flow gas turbine engine, the outer case assembly including an exhaust case defining openings;
a turbine exhaust duct fluidly communicating with the turbine section for receiving combustion gases, the turbine exhaust duct having:
an annular inlet conduit extending around the central axis; and
outlet conduits communicating with the annular inlet conduit and extending through the openings of the exhaust case, the outlet conduits extending from inlet ends at intersections with the annular inlet conduit to outlet ends, an outlet conduit of the outlet conduits having:
a transition area transitioning from a mainly axial direction to a mainly radial direction; and
a shielding plate secured to the transition area, the shielding plate being more resistant to the combustion gases than the outlet conduits.

12. The reverse-flow gas turbine engine of claim 11, wherein the shielding plate includes a thermal barrier coating on a gaspath side thereof, the gaspath side facing flow passages defined by the outlet conduits.

13. The reverse-flow gas turbine engine of claim 12, wherein the shielding plate includes a substrate coated with the thermal barrier coating.

14. The reverse-flow gas turbine engine of claim 11, wherein the shielding plate has a gaspath side exposed to the combustion gases and a rear side opposite the gaspath side and facing the transition area of the outlet conduit, the shielding plate having threaded shanks protruding from the rear side and extending through registering apertures defined by the transition area of the outlet conduit, the shielding plate secured to the transition area via the threaded shanks and nuts threaded to the threaded shanks.

15. The reverse-flow gas turbine engine of claim 14, wherein the registering apertures of the transition area are elongated, washers disposed between the nuts and the outlet conduit, the washers being elongated to each overlap an entirety of a respective one of the registering apertures.

16. The reverse-flow gas turbine engine of claim 14, wherein the outlet conduit defines a bore being overlapped by the shielding plate.

17. The reverse-flow gas turbine engine of claim 16, comprising a sealing member disposed between the shielding plate and the transition area of the outlet conduit, the sealing member surrounding the bore.

18. The reverse-flow gas turbine engine of claim 17, wherein the rear side of the shielding plate defines a groove between ribs, the sealing member received within the groove.

19. The reverse-flow gas turbine engine of claim 14, comprising posts protruding from the shielding plate and abutting the outlet conduit, the posts having a length being less than that of the threaded shanks.

20. The reverse-flow gas turbine engine of claim 11, wherein the outlet conduit defines a flow passage for the combustion gases, the transition area defines a recessed portion recessed outwardly away from the flow passage and sized for accommodating the shielding plate.
